(19) United States
(12) Patent Application Publication
(10) Pub. No.: US 2020/0239269 A1
(43) Pub. Date: Jul. 30, 2020

(54) CONTROLLING MOVEMENT OF AN ELEVATOR CAR

(71) Applicant: Otis Elevator Company, Farmington, CT (US)

(72) Inventors: Peter Herkel, Berlin (DE); Dirk H. Tegtmeier, Berlin (DE)

(21) Appl. No.: 16/721,337

(22) Filed: Dec. 19, 2019

(30) Foreign Application Priority Data
Jan. 25, 2019 (EP) 19153740.6

(51) Int. Cl. B66B 1/28; B66B 1/34; B66B 5/00; B66B 5/02

(52) U.S. Cl. CPC B66B 1/28; B66B 1/3492; B66B 5/0056; B66B 5/02; B66B 5/0031

(57) ABSTRACT

Elevator system includes a hoistway extending between a plurality of landings; an elevator car configured for moving along the hoistway between the plurality of landings; an elevator drive configured for driving the elevator car; a position determining system configured for determining the position of the elevator car within the hoistway; at least one switch; and an elevator controller. The elevator controller is configured for detecting an activation of the at least one switch; controlling the elevator drive to move the elevator car in a predetermined direction after the switch has been activated; determining the current position of the elevator car within the hoistway and comparing the determined position of the elevator car with at least one predefined positional limit (L_{UP}, L_{LOW}), while the elevator car is moving.

### FOREIGN PRIORITY

This application claims priority to European Patent Application No. 19153740.6, filed Jan. 25, 2019, and all the benefits accruing therefrom under 35 U.S.C. § 119, the contents of which in its entirety are herein incorporated by reference.

### BACKGROUND

The invention relates to a method of controlling movement of an elevator car within a hoistway of an elevator system. The invention further relates to an elevator system comprising a controller which is configured for employing such a method.

An elevator system typically comprises at least one elevator car moving along a hoistway extending between a plurality of landings, and an elevator drive configured for driving the elevator car. During operation of the elevator system, a controller is configured for controlling the elevator drive. This in particular includes limiting the movement of the elevator car to a predefined range between an upper and lower limit. The upper and lower limits are set providing sufficient space above and below the elevator car in order to prevent humans, in particular mechanics working within the hoistway, from being squeezed between the elevator car and the upper or lower ends of the hoistway.

During installation of the elevator system, the elevator car may be used as a tool for transporting material to the different landings. During said phase of installation, however, the controller is usually not yet adjusted to the specific dimensions of the elevator system. Instead, the elevator drive is operated manually for moving the elevator car to the desired position(s). In such a situation, there is a considerable risk that the elevator car is moved too close to one of the ends of the hoistway so that it does not provide a sufficiently large safe space for a human being present within the hoistway.

It therefore would be beneficial to enhance the safety of an elevator system, in particular when the elevator drive is operated manually, such as during installation of the elevator system.

### SUMMARY

According to an exemplary embodiment of the invention, a method of controlling movement of an elevator car within a hoistway of an elevator system includes: detecting an activation of a control switch and moving the elevator car in a predetermined direction after the control switch has been activated and/or while the control switch is activated. While the elevator car is moving, the current position of the elevator car within the hoistway is determined and the determined position of the elevator car is compared with at least one predefined positional limit. It in particular is checked whether the determined position corresponds to or is above a predefined upper positional limit or corresponds to or falls below a predefined lower positional limit. In case the determined position corresponds to or is beyond a predefined positional limit, the movement of the elevator car is stopped. In a following step, it is detected whether the control switch is activated again. In case the control switch is activated again, the movement of the elevator car is restarted for moving the elevator car further in the predetermined direction.

Exemplary embodiments of the invention further include an elevator system comprising a hoistway extending between a plurality of landings; an elevator car configured for moving along the hoistway between the plurality of landings; an elevator drive configured for driving the elevator car; a position determining system (“position reference system”) configured for determining the current position of the elevator car within the hoistway; at least one control switch; and an elevator controller.

According to an exemplary embodiment of the invention, the elevator controller is configured for detecting activation of the at least one control switch; controlling the elevator drive to move the elevator car in a predetermined direction after the control switch has been activated; while the elevator car is moving: determining the current position of the elevator car within the hoistway and comparing the determined position of the elevator car with at least one predefined positional limit; causing the elevator drive to stop the movement of the elevator car if the determined position is at or beyond a predefined positional limit; and controlling the elevator drive to start moving the elevator car further in the predetermined direction in case the at least one control switch is activated again.

A method of controlling movement of an elevator car within a hoistway of an elevator system according to an exemplary embodiment of the invention and an elevator system according to an exemplary embodiment of the invention allow moving the elevator car safely, in particular during an installation phase of the elevator system, when the elevator system is operated manually, for example for transporting material between different landings.

A number of optional features are set out in the following. These features may be realized in particular embodiments, alone or in combination with any of the other features, unless specified otherwise.

While the elevator car is moving, the position of the elevator car within the hoistway may be determined repeatedly or continuously, and the determined position of the elevator car may be compared with the at least one predefined positional limit repeatedly or continuously as well.

The predefined positional limit may be an upper positional limit set in a predefined upper distance from a preset uppermost position of the elevator car close to an upper end of the hoistway. An upper positional limit allows restricting the movement of the elevator car close to an upper end of the hoistway in order to provide a safe space large enough for a mechanic being present on top of the elevator car.

Similarly, the predefined positional limit may be a lower positional limit set in a predefined lower distance from a preset lowermost position of the elevator car close to a lower end (pit) of the hoistway. A lower positional limit allows restricting the movement of the elevator car close to a lower end of the hoistway in order to provide a safe space large enough for a mechanic being present at the lower end, in particular within a pit, of the hoistway.

The predefined upper and lower distances may be equal to each other. Alternatively, they may be different from each other.

The uppermost position of the elevator car may be readjusted according to the position of the elevator car in case the elevator car is moved above the previously set uppermost position of the elevator car.

The lowermost position of the elevator car may be readjusted according to the position of the elevator car in case the elevator car is moved below the previously set lowermost position of the elevator car.

Readjusting the uppermost/lowermost position of the elevator car in case the elevator car is moved below the previously set uppermost/lowermost position of the elevator car allows employing a method according to an exemplary embodiment of the invention without performing a dedicated calibration run for adjusting the elevator controller to the respective elevator system. This facilitates and allows to speed-up the installation process of the elevator system.

A method according to an exemplary embodiment of the invention may include issuing an alarm signal in case the elevator car is moved to or beyond a predefined positional limit in order to notify the person operating the movement of the elevator car that the elevator car has been moved to or beyond the predefined positional limit. The alarm signal may be an optical and/or an acoustic alarm signal.

At least one control switch may be arranged inside the elevator car, it in particular may be integrated with an elevator car control panel provided inside the elevator car.

Additionally or alternatively, at least one control switch may be arranged outside the elevator car, in particular on top of the elevator car, in order to allow a mechanic to control the movement of the elevator car from outside the elevator car.

Additionally or alternatively, at least one control switch may be arranged at at least one of the landings, e.g. within a landing control panel, and/or at a lower end, in particular within a pit, of the hoistway.

The position determining system may be an absolute position determining system configured for detecting and/or determining an absolute position of the elevator car within the hoistway. The position determining system in particular may include a coded tape extending along the length of the hoistway and a position sensor configured for interacting with the coded tape. An absolute position determining system allows determining the current position of the elevator car within the hoistway with high reliability and accuracy.

Alternatively of additionally, the position determining system may include a position sensor which is configured for determining the current position of the elevator car within the hoistway by detecting and integrating velocities and/or accelerations of the elevator car. A position sensor configured for determining the current position of the elevator car within the hoistway by detecting and integrating velocities and/or accelerations of the elevator car may be provided at comparatively low costs as it does not need a coded tape extending over the whole length of the hoistway.

### DRAWING DESCRIPTION

In the following, exemplary embodiments of the invention are described in more detail with respect to the enclosed figures:

FIG. 1 schematically depicts an elevator system with an elevator safety device according to an exemplary embodiment of the invention.

FIG. 2 depicts a flow diagram illustrating a method of controlling movement of an elevator car according to an exemplary embodiment of the invention.

FIG. 3 illustrates an elevator car in an uppermost position close to a top of the hoistway.

FIG. 4 illustrates an elevator car in a lowermost position close to a bottom of the hoistway.

### DETAILED DESCRIPTION

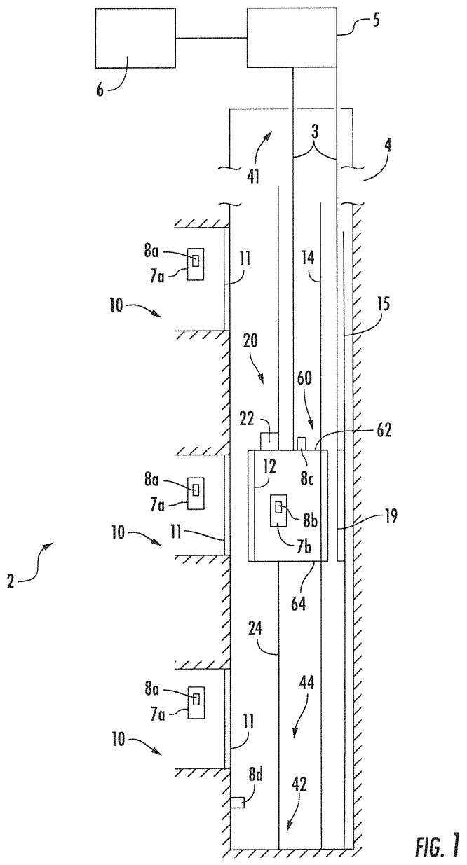

FIG. 1 schematically depicts an elevator system 2 according to an exemplary embodiment of the invention.

The elevator system 2 includes an elevator car 60 movably arranged within a hoistway 4 extending between a plurality of landings 10. The elevator car 60 in particular is movable in a longitudinal (vertical) direction along a plurality of car guide members 14, such as guide rails, extending along the vertical direction of the hoistway 4. Only one of said car guide members 14 is depicted in FIG. 1.

Although only one elevator car 60 is shown in FIG. 1, the skilled person understands that exemplary embodiments of the invention may include elevator systems 2 including a plurality of elevator cars 60 moving in one or more hoistways 4.

The elevator car 60 is movably suspended by means of a tension member 3. The tension member 3, for example a rope or belt, is connected to an elevator drive 5, which is configured for driving the tension member 3 in order to move the elevator car 60 along the height of the hoistway 4 between the plurality of landings 10, which are located on different floors.

The exemplary embodiment shown in FIG. 1 uses a 1:1 roping for suspending the elevator car 60. The skilled person, however, easily understands that the type of the roping is not essential for the invention and that different kinds of roping, e.g. a 2:1 roping or a 4:1 roping may be used as well.

The tension member 3 may be a rope, e.g. a steel wire rope, or a belt. The tension member 3 may be uncoated or may have a coating, e.g. in the form of a polymer jacket. In a particular embodiment, the tension member 3 may be a belt comprising a plurality of polymer coated steel cords (not shown). The elevator system 2 may have a traction drive including a traction sheave for driving the tension member 3. In an alternative configuration, which is not shown in the figures, the elevator system 2 may be an elevator system 2 without a tension member 3.

The elevator system 2 also may comprise e.g. a hydraulic drive or a linear drive. The elevator system 2 may have a machine room (not shown) or it may be a machine room-less elevator system 2.

The elevator system 2 further includes a counterweight 19 attached to the tension member 3 and configured for moving concurrently and in opposite direction with respect to the elevator car 60 along at least one counterweight guide member 15. The skilled person will understand that the invention may be applied also to elevator systems 2 which do not comprise a counterweight 19.

Each landing 10 is provided with a landing door 11, and the elevator car 60 is provided with a corresponding elevator car door 12 for allowing passengers to transfer between a landing 10 and the interior of the elevator car 60 when the elevator car 60 is positioned at the respective landing 10.

The elevator drive 5 is controlled by an elevator controller 6 for moving the elevator car 60 along the hoistway 4 between the different landings 10.

Input to the elevator controller 6 may be provided via landing control panels 7a, which are provided on each landing 10 close to the landing doors 11, and/or via an elevator car control panel 7b, which is provided inside the elevator car 60. Each of the control panels 7a, 7b may comprise at least one switch 8a, 8b which allows providing input to the elevator controller 6.

The landing control panels 7a and the elevator car control panel 7b may be connected to the elevator controller 6 by means of electric wires, which are not shown in FIG. 1, in particular by an electric bus, or by means of wireless data connections.

The elevator car 60 is equipped with at least one position determining system 20, which is configured for detecting the position of the elevator car 60 within the hoistway 4.

The position determining system 20 may be an absolute position determining system 20, including a position sensor 22 configured for interacting with a coded tape 24 extending along the length of the hoistway 4. Alternatively or additionally, the position determining system 20 may comprise a position sensor 22 which is configured for determining the current position of the elevator car 60 within the hoistway 4 by detecting and integrating velocities and/or accelerations of the elevator car 60.

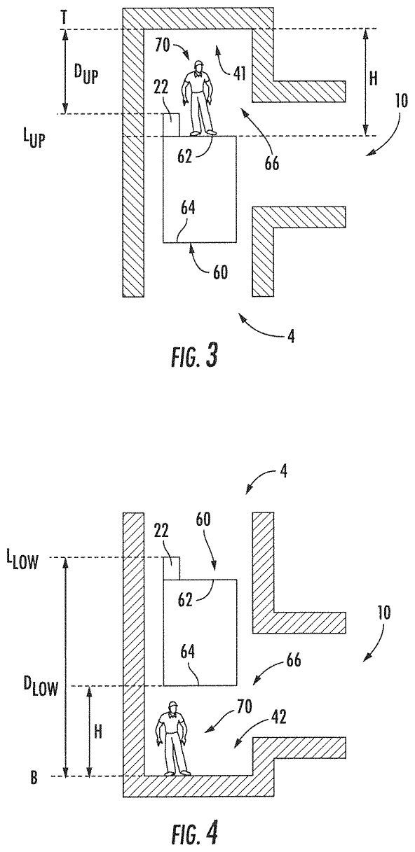

During installation of the elevator system 2, the elevator car 60 may be used for transporting material to the different landings 10. During installation, an automatic control of the elevator system 2 limiting the movement of the elevator car 60 at both ends 41, 42 of the hoistway 4 usually is not yet implemented. Instead, the movement of the elevator car 60 is controlled manually by a mechanic 70 (see FIGS. 3 and 4).

For manually controlling the movement of the elevator car 60, the mechanic 70 may operate switches 8a, 8b provided at the control panels 7a, 7b. Additional switches 8c, 8d allowing the mechanic 70 to manually control the movement of the elevator car 60 may be provided within the hoistway 4, in particular within a pit 44 at a lower end 42 of the hoistway 4, and/or outside, in particular on top or below, the elevator car 60.

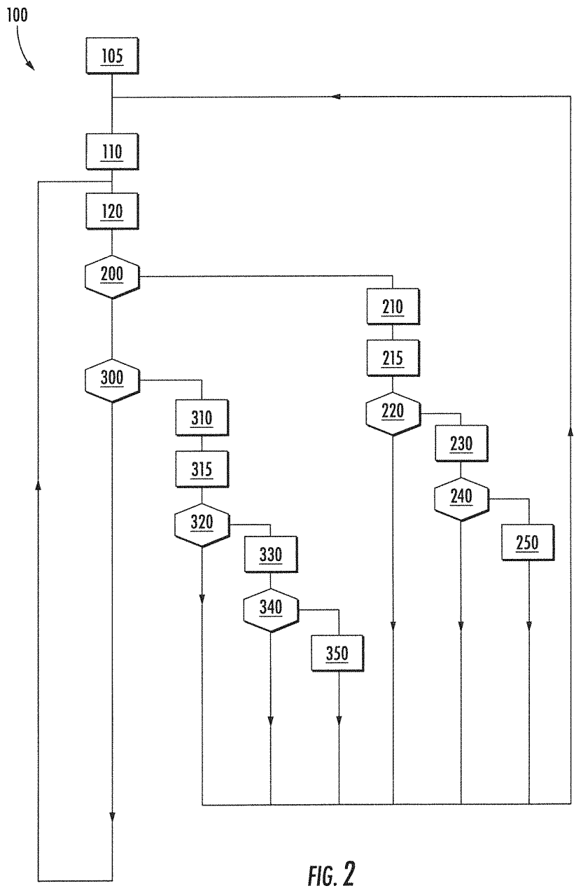

An exemplary embodiment of a method 100 of controlling movement of an elevator car 60 is illustrated by the flow diagram depicted in FIG. 2.

FIG. 3 illustrates the elevator car 60 in an uppermost position close to a top T of the hoistway 4, and FIG. 4 illustrates the elevator car 60 in a lowermost position close to a bottom B of the hoistway 4.

At the beginning (in step 105), a (virtual) top T and a (virtual) bottom B of the hoistway 4 are set within the elevator controller 6. The details of setting the top T and the bottom B of the hoistway 4 are discussed in more detail further below.

In step 110, movement of the elevator car 60 is started by the mechanic 70 by activating one of the switches 8a-8d. For safety reasons, each of the switches 8a-8d may be configured so that two hands are necessary for activating the respective switch 8a-8d. For example, it may be necessary to press two buttons simultaneously for activating the respective switch 8a-8d.

In order to prevent humans, in particular mechanics 70, present in the hoistway 4 from being squeezed below or above the elevator car 60, i.e. between a ceiling 62 of the elevator car 60 and an upper end 41 of the hoistway 4, or between the bottom 64 of the elevator car 60 and a lower end 42 of the hoistway 4, the elevator controller 6 is configured for monitoring the current position of the elevator car 60 (step 120) based on a positional signal provided by the position sensor 22 while the elevator car 60 is moving. The elevator controller 6 in particular may be configured for monitoring the current position of the elevator car 60 continuously or repeatedly.

In step 200 the current position of the elevator car 60 as indicated by the positional signal is compared with a predefined upper positional limit L_{UP} (cf. FIG. 3).

In case the current position of the elevator car 60, in particular the position of the position sensor 22 of to the elevator car 60, is below the predefined upper positional limit L_{UP}, the current position of the elevator car 60 is compared in step 300 with a predefined lower positional limit L_{LOW} (cf. FIG. 4) while the elevator car 60 is moving.

As long as the elevator car 60 is located between the predefined upper and lower positional limits L_{UP}, L_{LOW}, the elevator car 60 is allowed to continue its movement and the controller 6 circulates through steps 120, 200, 300 monitoring the current position of the elevator car 60 with respect to the upper and lower positional limits L_{UP}, L_{LOW}.

In case, however, the controller 6 determines in step 200 that the current position of the elevator car 60, in particular the position of the position sensor 22 of to the elevator car 60, reaches or exceeds the predefined upper positional limit L_{UP}, i.e. in case the elevator car 60 is moved upwards to or beyond the predefined upper positional limit L_{UP}, the movement of the elevator car 60 is stopped (step 210). Optionally, an acoustic and/or optical alarm signal is generated (step 215) for notifying the mechanic 70 controlling the movement of the elevator car 60 that the upper positional limit L_{UP} has been reached or exceeded.

Next, it is checked (in step 220) whether the mechanic 70 has activated one of the switches 8a-8d, in particular the same switch 8a-8d or the same combination of switches 8a-8d which he has activated for starting the movement of the elevator car 60, again. In case the same switch 8a-8d is activated again, movement of the elevator car 60 is restarted (step 230) for moving the elevator car 60 in the same direction as before, i.e. upwards in the present example.

The elevator controller 6 in particular may be configured for causing the elevator drive 5 to move the elevator car 60 upwards as long as the switch 8a-8d or the combination of switches 8a-8d is activated, e.g. as long as a button or a combination of buttons configured for activating the switch 8a-8d is pressed. Such a configuration allows the mechanic 70 to move the elevator car 60 to a desired position close to the upper end 41 (top T) of the hoistway 4 (see FIG. 3).

Alternatively to moving the elevator car 60 further upwards by activating the same switch 8a-8d again, the elevator car 60 may be moved in the opposite direction, i.e. downwards, by activating another switch 8a-8d or another combination of switches 8a-8d (step 110). In this case, the method 100 continues with monitoring the current position of the elevator car 60 (step 120).

In case the current position of the elevator car 60 falls below the predefined lower positional limit L_{LOW}, i.e. the elevator car 60 moves to or below the predefined lower positional limit L_{LOW}, the movement of the elevator car 60 is stopped (step 310). Optionally, an acoustic and/or optical alarm signal is generated (in step 315) for notifying the mechanic 70 controlling the movement of the elevator car 60 that the elevator car 60 has moved to or below the lower positional limit L_{LOW}.

Next, it is checked (in step 320) whether the mechanic 70 has activated a switch 8a-8d, in particular the same switch 8a-8d or the same combination of switches 8a-8d which he has activated for starting the movement of the elevator car 60 in the beginning, again. In case the same switch 8a-8d or the same combination of switches 8a-8d is activated again, movement of the elevator car 60 is restarted (step 330) for moving the elevator car 60 in the same direction as before, i.e. downwards in the present example.

The elevator car 60 in particular may continue to move downwards as long as the respective switch 8a-8d or the same combination of switches 8a-8d is activated. This allows the mechanic 70 to move the elevator car 60 to a desired position close to the lower end 42 (bottom B) of the hoistway 4 (see FIG. 4).

Alternatively to moving the elevator car 60 further downwards by activating the same switch 8a-8d again, the elevator car 60 may be moved in the opposite direction, i.e. upwards, by activating another switch 8a-8d or another combination of switches 8a-8d (step 110). In this case, the method continues with monitoring the current position of the elevator car 60 (step 120).

The predefined upper positional limit L_{UP} is set in a predefined upper distance d_{UP} from the top T of the hoistway 4 (cf. FIG. 3). Similarly, the predefined lower positional limit L_{LOW} is set in a predefined lower distance d_{LOW} from the bottom B of the hoistway 4 (cf. FIG. 4).

The predefined upper and lower distances d_{UP} and d_{LOW} may be identical (d_{UP}=d_{LOW}) or different (d_{UP}≠d_{LOW}). The predefined upper and lower distances d_{UP} and d_{LOW} in particular may be set so that a safe space 66, which is large enough for accommodating a human/mechanic 70, is provided between the ceiling 62/bottom 64 of the elevator car 60 and the top T/bottom B of the hoistway 4, respectively. The upper and/or lower distances d_{UP}, d_{LOW} in particular may be set so that the safe space 66 has a height H between 1 m and 2 m.

During installation of a new elevator system 2, the elevator controller 6 has not been specifically adapted to the elevator system 2 yet. In consequence, the actual positions of the top T and bottom B of the hoistway 4 are usually not known to the elevator controller 6.

Thus, at the beginning (in step 105), for the purpose of controlling the movement of the elevator car 60 according to an exemplary embodiment of the invention, the current position of the elevator car 60 at the beginning is set as the top T and as the bottom B of the hoistway 4, respectively.

It is noted that the top T and the bottom B set are set provisionally in step 105 and in particular in general do not coincide with the physical upper and lower ends 41, 42 of the hoistway 4, respectively.

After each upward movement of the elevator car 60 to or beyond the upper limit L_{UP} has been completed, it is checked (in step 240 in FIG. 2) whether the elevator car 60 has been moved above the previously set top T of the hoistway 4. In case the elevator car 60 has been moved to or beyond the previously set top T of the hoistway 4, the previously set top T of the hoistway 4 is readjusted in step 250 by setting the current position of the elevator car 60 at the end of the respective movement as the new top T of the hoistway 4.

After each downward movement of the elevator car 60 to or beyond the lower limit L_{LOW} has been completed, it is checked (in step 340 in FIG. 2) whether the elevator car 60 has been moved below the previously set bottom B of the hoistway 4. In case the elevator car 60 has been moved downwards below the previously set bottom B of the hoistway 4, the previously set top T of the hoistway 4 is readjusted in step 350 by setting the current position of the elevator car 60 as the new bottom B of the hoistway 4.

For example, in case the method 100 of controlling the movement of an elevator car 60 is started with the elevator car 60 being positioned at a landing 10 corresponding to the 3^{rd} floor, and the elevator car 60 is moved to a landing 10 corresponding to the 5^{th} floor, the position of the elevator car 60 positioned at the landing 10 corresponding to the 5^{th} floor is set as the new top T of the hoistway 4 and the upper limit L_{UP} is set in the predefined upper distance d_{UP} below said position corresponding to the new top T of the hoistway 4.

In consequence, any subsequent upward movement of the elevator car 60 is stopped automatically as soon as the elevator car 60 reaches the upper limit L_{UP} corresponding to the position of the elevator car 60 at 5^{th} floor.

In case the mechanic 70 moves the elevator car 60 beyond the upper limit L_{UP} by reactivating an appropriate switch 8a-8d or an appropriate combination of switches 8a-8d, e.g. to a landing 10 corresponding to the 6^{th} floor, the new position of the elevator car 60 at the end of said movement is set as the new top T of the hoistway 4 replacing the previously set top T of the hoistway 4. The upper limit L_{UP} is adjusted accordingly in the predefined upper distance d_{UP} from the (new) top T of the hoistway 4. In consequence, any subsequent upward movement of the elevator car 60 will not be stopped at the predefined upper distance d_{UP} below the landing 10 corresponding to the 5^{th} floor, but only at the predefined upper distance d_{UP} from the landing 10 corresponding to the 6^{th} floor.

It is easy to understand that this procedure may be repeated any time the elevator car 60 is moved beyond a previously set upper limit L_{UP}.

The procedure described with respect to upward movements of the elevator car 60 equivalently may be applied to downward movements of the elevator car 60 for adjusting the bottom B of the hoistway 4 and the associated lower positional limit L_{LOW} for downward movements of the elevator car 60.

After the elevator cat 60 has been moved at least once to the (real, i.e. physical) upper end 41 of the hoistway 4 and to the (real, i.e. physical) lower end 42 of the hoistway 4, the elevator controller 6 has been adjusted to the elevator system 2. As a result, the elevator controller 6 will stop the elevator car 60 automatically only when the elevator car 60 is moved closer than the predefined upper and lower distances d_{UP}, d_{LOW} to the upper and lower ends 41, 42 of the hoistway 4, respectively.

In consequence, a method 100 of controlling movement of an elevator car 60 within a hoistway 4 of an elevator system 2 according to an exemplary embodiment of the invention allows moving the elevator car 60 safely. It in particular allows moving the elevator car 60 safely during the installation phase of the elevator system 2, when the elevator system 2 is usually operated manually, for example for transporting material between the different landings 10.

Due to the automatic adjustments of the top T and bottom B of the hoistway 4, as it has been described before, a method 100 according to an exemplary embodiment of the invention may be employed without performing a dedicated calibration run for adjusting the elevator controller 6 to the respective elevator system 2. As a result, the elevator system 2 may be installed faster without deteriorating its safety.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 elevator drive
6 elevator controller
7a landing control panel
7b elevator car control panel
8a switch
8b switch
8c switch
8d switch
10 landing
11 landing door
12 elevator car door
14 car guide member
15 counterweight guide member
19 counterweight
20 position determining system
22 position sensor
24 coded tape
41 upper end of the hoistway
42 lower end of the hoistway
44 pit
60 elevator car
62 ceiling of the elevator car
64 bottom of the elevator car
66 safe space
70 mechanic
B bottom of the hoistway
d_{LOW} lower distance
d_{UP} upper distance
H height of the safe space
L_{LOW} lower limit
L_{UP} upper limit
T top of the hoistway

What is claimed is:

1. Method of controlling movement of an elevator car (60) within a hoistway (4) of an elevator system (2), wherein the method includes:
detecting an activation of a switch (8a-8d);
moving the elevator car (60) in a predetermined direction after the switch (8a-8d) has been activated and/or while the switch (8a-8d) is activated;
while the elevator car (60) is moving: determining the current position of the elevator car (60) within the hoistway (4) and comparing the determined position of the elevator car (60) with at least one predefined positional limit (L_{UP}, L_{LOW});
stopping the movement of the elevator car (60) if the determined position reaches or is beyond at least one predefined positional limit (L_{UP}, L_{LOW});
detecting an activation of the switch (8a-8d);
starting to move the elevator car (60) further in the predetermined direction in case the switch (8a-8d) is activated again.

2. Method according to claim 1, wherein the predefined positional limit (L_{UP}) is an upper positional limit (L_{UP}) which is set in a predefined upper distance (d_{UP}) from a preset uppermost position of the elevator car (60).

3. Method according to claim 2, wherein the uppermost position of the elevator car (60) is readjusted according to the position of the elevator car (60) in case the elevator car (60) is moved above the previously set uppermost position of the elevator car (60).

4. Method according to claim 1, wherein the predefined positional limit (L_{LOW}) is a lower positional limit (L_{LOW}) which is set in a predefined lower distance (d_{LOW}) from a preset lowermost position of the elevator car (60).

5. Method according to claim 4, wherein the lowermost position of the elevator car (60) is readjusted according to the position of the elevator car (60) in case the elevator car (60) is moved below the previously set lowermost position of the elevator car (60).

6. Method according to claim 1, wherein the method includes issuing an alarm signal in case the elevator car (60) is moved to or beyond a predefined positional limit (L_{UP}, L_{LOW}), respectively.

7. Method according to claim 1, wherein the alarm signal includes an optical and/or an acoustic alarm signal.

8. Elevator system (2) comprising:
a hoistway (4) extending between a plurality of landings (10);
an elevator car (60) configured for moving along the hoistway (4) between the plurality of landings (10);
an elevator drive (5) configured for driving the elevator car (60);
a position determining system (20) configured for determining the position of the elevator car (60) within the hoistway (4);
at least one switch (8a-8d); and
an elevator controller (6) configured for:
detecting an activation of the at least one switch (8a-8d);
controlling the elevator drive (5) to move the elevator car (60) in a predetermined direction after the switch (8a-8d) has been activated;
while the elevator car (60) is moving: determining the current position of the elevator car (60) within the hoistway (4) and comparing the determined position of the elevator car (60) with at least one predefined positional limit (L_{UP}, L_{LOW});
causing the elevator drive (5) to stop the movement of the elevator car (60) if the determined position is at or beyond at least one predefined positional limit (L_{UP}, L_{LOW});
detecting an activation of the at least one switch (8a-8d);
controlling the elevator drive (5) to start moving the elevator car (60) further in the predetermined direction in case the at least one switch (8a-8d) is activated again.

9. Elevator system (2) according to claim 8, wherein the position determining system (20) is an absolute position determining system (20) configured for determining an absolute position of the at least one elevator car (60) within the at least one hoistway (4).

10. Elevator system (2) according to claim 8, wherein at least one switch (8a-8d) is arranged inside the elevator car (60).

11. Elevator system (2) according to claim 8, wherein at least one switch (8a-8d) is arranged on top of the elevator car (60).

12. Elevator system (2) according to claim 8, wherein at least one switch (8a-8d) is arranged at at least one of the landings (10) and/or at a lower end (42), in particular in a pit (44), of the hoistway (4).

13. Elevator system (2) according to claim 8, wherein the position determining system (20) is an absolute position determining system (20), in particular including a coded tape (24) extending along the length of the hoistway (4) and a position sensor (22) configured for interacting with the coded tape (24).

14. Elevator system (2) according to claim 8, wherein the position determining system (20) includes a position sensor (22), which is configured for determining the current position of the elevator car (60) within the hoistway (4) by detecting and integrating velocities and/or accelerations of the elevator car (60).
